(19) United States
(12) Patent Application Publication
(10) Pub. No.: US 2011/0019171 A1
(43) Pub. Date: Jan. 27, 2011

(54) OPTICAL UNIT HAVING ADJUSTABLE FORCE ACTION ON AN OPTICAL MODULE

(75) Inventors: Erich Schubert, Ellwaagen (DE); Andreas Heisler, Steinheim (DE); Joachim Hartjes, Aalen (DE)

Correspondence Address: FISH & RICHARDSON P.C. (BO), P.O. BOX 1022, MINNEAPOLIS, MN, 55440-1022, US

(73) Assignee: CARL ZEISS SMT AG, Oberkochen (DE)

(21) Appl. No.: 12/730,395

(22) Filed: Mar. 24, 2010

Related U.S. Application Data
(63) Continuation of application No. PCT/EP2008/008176, filed on Sep. 25, 2008.
(60) Provisional application No. 60/974,947, filed on Sep. 25, 2007.

(30) Foreign Application Priority Data
Sep. 25, 2007 (DE) 10 2007 045 975.2

(51) Int. Cl. G03B 27/54; G02B 7/00

(52) U.S. Cl. 355/67; 359/896

(57) ABSTRACT

The present disclosure relates to an optical device, in particular for microlithography, having an optical module, a supporting structure and a force-generating device. The force-generating device is connected to the optical module and the supporting structure and is designed to exert a clamping force on the optical module. The force-generating device has a fluidic force-generating element having a working chamber to which a working fluid having a working pressure can be applied. The force-generating element takes the form of a muscle element which exerts a first tensile force at a first working pressure and a second tensile force which is increased with respect to the first tensile force at a second working pressure which is increased with respect to the first working pressure.

### CROSS-REFERENCE TO RELATED APPLICATIONS

This application is a continuation of, and claims benefit under 35 USC 120 to, international application PCT/EP2008/008176, filed Sep. 25, 2008, which claims benefit of German Application No. 10 2007 045 975.2, filed Sep. 25, 2007 and U.S. Ser. No. 60/974,947, filed Sep. 25, 2007. International application PCT/EP2008/008176 is hereby incorporated by reference in its entirety.

### FIELD

The present disclosure relates to an optical device, to an optical imaging device which includes an optical device of this kind, and to a method of exerting a force on an optical module of an optical device. The disclosure can be used in connection with any desired optical devices or optical imaging methods. In particular, it can be used in connection with microlithography as used in the production of microelectronic circuits.

### BACKGROUND

Particularly in the field of microlithography, there is a need, among others, not only for components with the greatest possible accuracy to be used but also for the position and geometry of optical modules of the imaging device, i.e. for example, the modules having optical elements such as lenses, mirrors or gratings but also the masks and substrates which are used, to be set during operation, as accurately as possible, to preset setpoint values or for such components to be held in a position to which they have once been adjusted, to enable image forming of a correspondingly high quality to be achieved (the term optical module being intended to mean, for the purposes of the present disclosure, both optical elements alone as well as assemblies of such optical elements and other components such for example as mounting parts, etc.).

In the field of microlithography, the desired accuracy properties lie in the microscopic area in the order of magnitude of a few nanometres or less. They are the result of, not least, the constant demand for the resolution of the optical systems used in the production of microelectronic circuits to be increased in order to push ahead with the miniaturisation of the microelectronic circuits to be produced. Particularly in modern-day lithographic systems, which operate at a high numerical aperture to increase resolution, operation takes place with highly polarised UV light to enable the advantages of the high numerical aperture to be fully exploited. Hence, it is of particular importance in this case for the polarisation of light to be maintained as it passes through the optical system. Something which is found to be a particular problem in this case is the stress-induced birefringence which is caused by stresses in the optical elements and which is responsible for a substantial fraction of the loss of polarisation in the system.

Two different concepts are usually employed to hold an adjusted component, such as an optical element for example, in a position to which it has once been adjusted. On the one hand, firmly bonded connections are used between the optical element and its supporting structure. These connections do, however, have the disadvantage not only of the possibly inadequate long-term stability of the connection under the influence of UV light but also that the making of the firmly bonded connection may possibly go hand in hand with the generation of parasitic forces (due for example to the shrinkage of the adhesive used, etc.) which result in unwanted stresses in the optical element, in a loss of polarisation and hence in a degradation of the quality with which images are formed.

Alternatively, frictional connections, such as for example clamping connections, are often used between the optical element and the supporting structure (particularly in illumination systems) because these connections are particularly simple to make and, among others, because they do not cause any problems with regard to long-term stability even under the influence of UV light. The holding force is generally produced in this case by an elastic restoring force in a deformed resilient member or the like.

However, there is a problem with such frictional connections which lies in the fact that the holding force to be generated has to be designed for the maximum de-adjusting force which can be expected once the optical element has been adjusted. However, this maximum de-adjusting force is of course based on particularly pessimistic assumptions, i.e. on the maximum de-adjusting force which can be expected in the worst possible situation (which is possibly increased still further by an appropriate safety factor). This maximum de-adjusting force is typically a force which is expected to occur as a result of impacts in the course of transport or as a result of unusual events occurring during the operation of the optical device once it has been adjusted, even though during normal operation of the optical device, predominantly, considerably lower de-adjusting forces are to be expected.

Hence, in a typical example of a microlithography apparatus during normal operation, predominantly, a maximum acceleration of 3 g (i.e. three times the acceleration caused by the earth's gravity) is to be expected to act on the components, whereas what is taken as a basis for the extreme case is impacts in which a maximum acceleration of 7 g (i.e. seven times the acceleration caused by the earth's gravity) acts on the components. However, because the holding force has to be designed to suit this extreme case, what is consequently exerted in normal operation is a holding force which is higher than is actually necessary. However, this holding force which is dispensably high for long stretches in turn causes high stresses in the optical element and, hence, a loss of polarisation and the degradation in the quality of the image forming which goes hand in hand with it.

To achieve the desired position and/or geometry of the optical modules concerned which was mentioned above, what are also often used are active manipulators which exert a corresponding manipulating force on the component. In particular in the field of microlithography, what are often used in this case are piezo actuators, Lorentz actuators, pneumatic bellows actuators or the like. However, these types of actuator each have not inconsiderable disadvantages.

It may be true that manipulating forces which can be varied over a wide range can easily be generated with the known piezo actuators. However, they do have the disadvantage that the piezo elements which are used on the one hand provide only a comparatively short actuating travel, thus making expensive gearing involved for longer actuating travels. On the other hand the piezo elements are comparatively brittle and are sensitive to shear and tensile stresses, which means that they can only be loaded in relatively precisely defined directions and that there is a high risk of damage particularly if there are impacts loads. Finally, the comparatively high stiffness of the piezo elements also implicates the disadvantage that, for certain applications, particularly in the field of microlithography, additional mechanical decoupling from the components to be manipulated is involved to prevent parasitic forces and moments from being applied to the components.

It may be true that Lorentz actuators have the advantage that their stiffness is very low. A disadvantage, however, is that they often have only limited actuating travels and provide low manipulating forces. Also, they produce comparatively high dissipated power which causes problems or involves expensive provisions for heat removal, particularly in the case of optical devices which are very sensitive thermally.

It may be true that pneumatic bellows actuators are able to provide high manipulating forces and long actuating travels when desired. However, they do have the disadvantage that they take up a comparatively large amount of space and can likewise only be subjected to loads in a comparative precisely defined direction if the risk of damage is to be kept low.

### SUMMARY

The present disclosure provides an optical device, an optical imaging device, and a method of exerting a force on an optical module of an optical device which do not have the above-mentioned disadvantages or at least have them to a lesser degree and which, in particular, in an easy manner ensure image forming of high quality during operation.

The present disclosure is based on the one hand on the finding that image forming of particularly high quality can easily be achieved by using a fluidic force-generating element formed in the manner of a muscle element to apply a force to an optical module, which force-generating element desires to perform a contraction if there is an increase in pressure in its working chamber and in so doing exerts an increasing tensile force. Muscle elements of this kind have, on the one hand, the advantage that they operate without jerks or impacts, thus enabling the force to be exerted on the optical module particularly gently. This in turn has the advantage that other components of the apparatus are not affected by any impacts which may occur when the muscle element is operated. A further advantage of fluidic muscle elements of this kind lies in the fact that, because of their principle of operation of a contraction along their longitudinal axis upon an increase in the working pressure and because of the resultant exertion of a tensile force, they are insensitive to shear forces, which considerably simplifies the design of the force-generating device. In this way, appreciably less expense is involved in decoupling such shear forces or in the guidance relative to one another of the coupled components as compared with conventional fluidic actuators operating in a similar jerk-free manner (e.g. conventional bellows actuators which exert a compressive force when there is an increase in the working pressure).

According to a first aspect, the present disclosure therefore relates to an optical device, in particular for microlithography, having an optical module, a supporting structure and a force-generating device. The force-generating device is connected to the optical module and the supporting structure and is designed to exert a force on the optical module. The force-generating device has a fluidic force-generating element having a working chamber to which a working fluid having a working pressure can be applied. The force-generating element is designed as a muscle element which exerts a first tensile force at a first working pressure and exerts a second tensile force which is increased with respect to the first tensile force at a second working pressure which is increased with respect to the first working pressure.

According to a further aspect, the present disclosure relates to an optical imaging device, in particular for microlithography, having an illumination device, a mask device for receiving a mask which includes a projection pattern, a projection device having a group of optical elements, and a substrate device for receiving a substrate. The illumination device is designed to illuminate the projection pattern, whereas the group of optical elements is designed to form an image of the projection pattern on the substrate. The illumination device and/or the projection device include an optical module having a supporting structure and a force-generating device. The force-generating device is connected to the optical module and the supporting structure and is designed to exert a force on the optical module. The force-generating device also has a fluidic force-generating element having a working chamber to which a working fluid having a working pressure can be applied. The force-generating element is designed as a muscle element which exerts a first tensile force at a first working pressure and a second tensile force which is increased with respect to the first tensile force at a second working pressure which is increased with respect to the first working pressure.

According to a further aspect, the present disclosure relates to a method of exerting a force on an optical module, in particular for use in microlithography, in which the optical module is supported by a supporting structure, a force being exerted on the optical module by a force-generating device which is connected to the optical module and the supporting structure and which has a fluidic force-generating element with a working chamber to which a working fluid having a working pressure can be applied. What is used as a force-generating element is an element which is designed as a muscle element exerting a first tensile force at a first working pressure and a second tensile force which is increased with respect to the first tensile force at a second working pressure which is increased with respect to the first working pressure.

The present disclosure is based on the other hand on the realization that, irrespective of whether a muscle element of this kind is used, image forming of particularly high quality can be achieved if, in case of a clamped connection between the supporting structure and the optical module, the clamping force can be varied under the control of a control device and in particular as a function of the acceleration acting on the optical module. This has the advantage that the clamping force can be matched to whatever is the current operating situation at the time and does not need to permanently correspond to that clamping force which is involved for the worst-case load which can be expected (which occurs extremely rarely or even never). In other words, it is possible by this approach to operate for long stretches of operation with clamping forces which are considerably reduced in comparison with those in a comparable conventional optical device. Consequently, due to the reduced clamping forces, the stresses which are exerted on the optical module and which might result in a reduction in the quality of the image forming (e.g. due to stress-induced birefringence) are appreciably lower in normal operating situations where there are no extreme operating conditions of the kind mentioned (e.g. high impact loads or the like).

It is also possible by this approach for the clamping forces to be held constant as a function of the accelerations acting on the optical module, at least for certain stretches, in order to keep, in this way, the effects of the overall forces acting on the optical module (i.e. the clamping forces and the inertial forces) on the optical properties of the optical module as constant as possible. In this way, provision may for example be made for the clamping forces to be reduced in cases where, due to the acceleration of the optical module and the increased contact forces resulting therefrom (which are the result of the inertial forces acting on the optical module), only lower clamping forces are still desired in the region of the clamping action to hold the optical module in position.

It goes without saying that in these variants of the disclosure, the given acceleration can be taken into account in arbitrary degrees of freedom and in as many degrees of freedom as desired together (up to all six degrees of freedom in three-dimensional space).

It should also be mentioned that this active variation of the clamping force during the operation of the optical device does not depend on the way in which the clamping force is generated. All that is involved is the clamping force can be actively varied in operation by an appropriate control device. Any desired principles of operation can be considered for the generation of the clamping force. What may be used, in particular, are sufficiently well known electrical or electro-mechanical force-generating elements (e.g. piezo actuators, Lorentz actuators, etc.) or fluidic force-generating elements (e.g. piston, diaphragm or bellows actuators, fluidic muscle elements, etc.).

According to a further aspect, the present disclosure therefore relates to an optical device, in particular for microlithography, having an optical module, a supporting structure and a force-generating device, the force-generating device being connected to the optical module and the supporting structure and being designed to exert a clamping force on the optical module. The force-generating device is designed to vary the clamping force under the control of a control device which is connected to it.

According to a further aspect, the present disclosure relates to an optical imaging device, in particular for microlithography, having an illumination device, a mask device for receiving a mask including a projection pattern, a projection device having a group of optical elements, and a substrate device for receiving a substrate, the illumination device being designed to illuminate the projection pattern, whereas the group of optical elements is designed to form an image of the projection pattern on the substrate. The illumination device and/or the projection device includes an optical module having a supporting structure and a force-generating device. The force-generating device is connected to the optical module and the supporting structure and is designed to exert a clamping force on the optical module. The force-generating device is designed to vary the clamping force under the control of a control device which is connected to it.

According to a further aspect, the present disclosure relates to a method of exerting a force on an optical module, in particular for use in microlithography, in which the optical module is supported by a supporting structure, a clamping force being exerted on the optical module by a force-generating device which is connected to the optical module and the supporting structure and the clamping force being varied under the control of a control device.

Other exemplary embodiments of the disclosure will become apparent from the dependent claims and from the following description of exemplary embodiments, which refers to the accompanying drawings.

### BRIEF DESCRIPTION OF THE DRAWINGS

FIG. 1 is a schematic view of an exemplary embodiment of an optical imaging device according to the disclosure which includes an optical device according to the disclosure and with which an exemplary embodiment of a method of exerting a force according to the disclosure can be carried out.

FIG. 2 is a highly generalised schematic view of part of an exemplary embodiment of the optical device according to the disclosure of the imaging device shown in FIG. 1.

FIG. 3 is a block diagram of an exemplary embodiment of the method according to the disclosure of exerting a force which can be carried out with the optical device shown in FIG. 2.

FIG. 4 is a schematic view of part of a further exemplary embodiment of the optical device according to the disclosure of the imaging device shown in FIG. 1.

FIG. 5 is a block diagram of an exemplary embodiment of the method of exerting a force according to the disclosure which method can be carried out with the optical device shown in FIG. 4.

FIG. 6 is a schematic view of part of a further exemplary embodiment of the optical device according to the disclosure of the imaging device shown in FIG. 1.

FIG. 7 is a schematic view of part of a further exemplary embodiment of the optical device according to the disclosure of the imaging device shown in FIG. 1.

FIG. 8 is a schematic view of part of a further exemplary embodiment of the optical device according to the disclosure of the imaging device shown in FIG. 1.

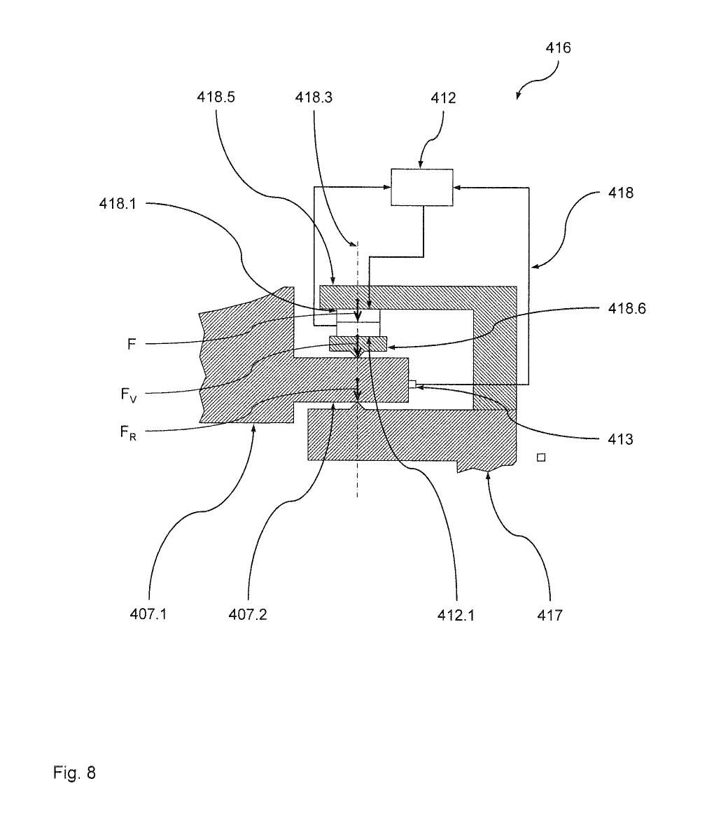

### DETAILED DESCRIPTION OF THE DISCLOSURE

### First Exemplary Embodiment

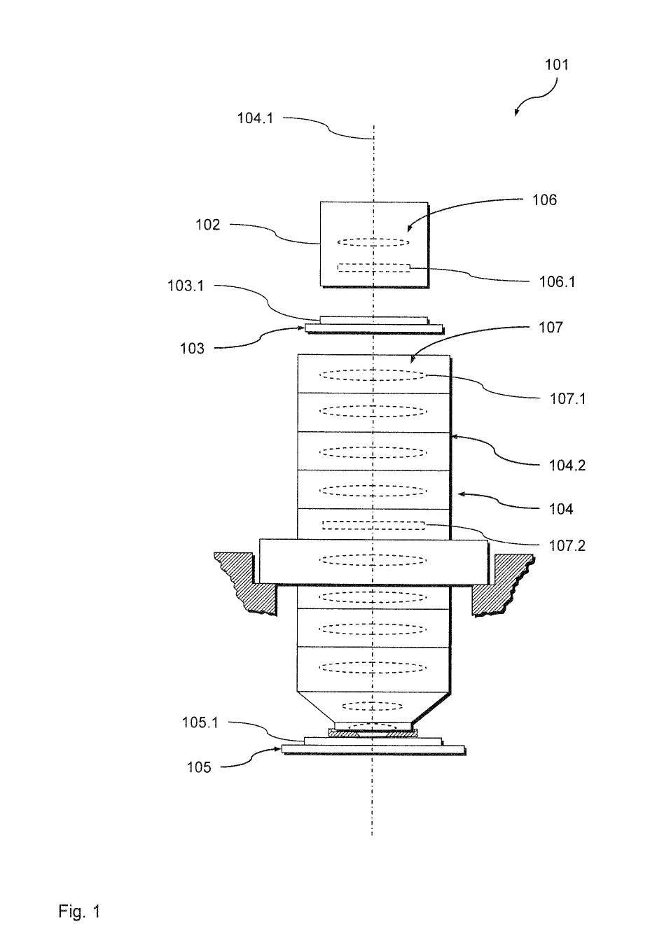

With reference to FIGS. 1 to 3, there will be described in the following an exemplary embodiment of the optical device according to the disclosure which is used in an optical imaging device according to the disclosure for microlithography.

FIG. 1 is a schematic view of an exemplary embodiment of the optical imaging device according to the disclosure in the form of a microlithographic apparatus which works with light in the UV range of a wavelength of 193 nm.

The microlithographic apparatus 101 includes an illumination system 102, a mask device in the form of a mask table 103, an optical projection system in the form of an objective 104 having an optical axis 104.1 and a substrate device in the form of a wafer table 105. The illumination system 102 illuminates a mask 103.1 arranged on the mask table 103 with a beam of projecting light (not shown in more detail) of the wavelength 193 nm. Situated on the mask 103.1 is a projection pattern which is projected by the beam of projecting light via the optical elements arranged in the objective 104 onto a substrate in the form of a wafer 105.1 which is arranged on the wafer table 105.

Apart from a light source (not shown), the illumination system 102 also includes a first group 106 of optically active components which include among others a bar shaped optical element 106.1. Because of the working wavelength of 193 nm, the optical element 106.1 is a refractive element.

The objective 104 includes a second group 107 of optically active elements which includes among others a series of optical elements such for example as the optical element 107.1. The optically active components in the second group 107 are held in place in the housing 104.2 of the objective 104. Because of the working wavelength of 193 nm, the optical element 107.1 is a refractive optical element, i.e. a lens or the like. However, it goes without saying that any desired other optical elements, such as for example reflective or diffractive optical elements, can also be used on other variants of the disclosure. Similarly, any desired combinations of such optical elements may of course also be used.

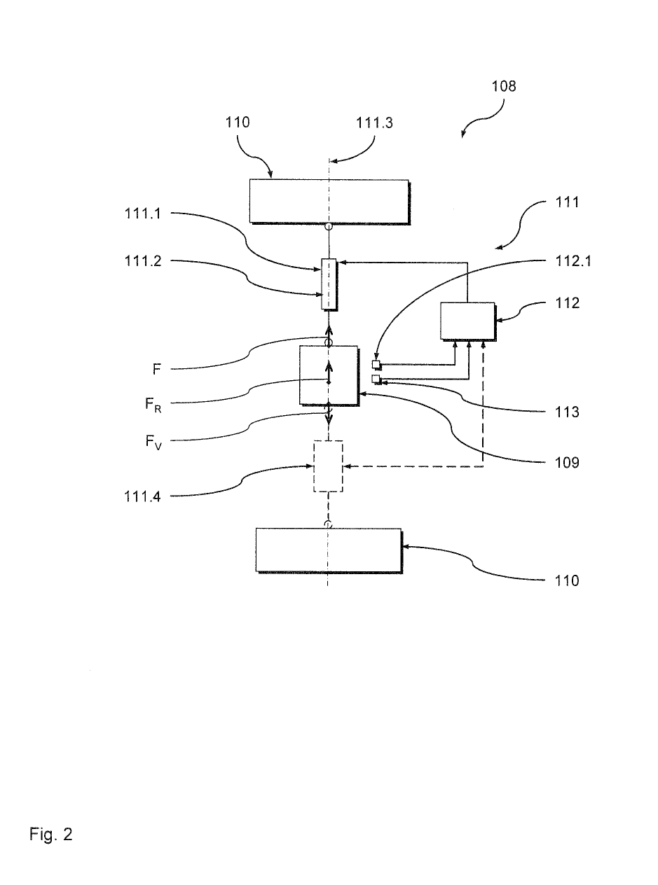

FIG. 2 is a highly schematic view of an optical device 108 according to the disclosure which includes an optical module 109, a supporting structure 110 and a force-generating device 111. The supporting structure 110 supports the optical module 109. For this purpose, the supporting structure 110 (as well as other supporting elements if desired) is connected to the optical module 109 by the force-generating device 111. The optical module 109 includes the lens 107.1 (and other components if desired such as for example a holding device connected to the lens 107.1, with which the force-generating device 111 engages).

The purpose of the force-generating device 111 is to exert a force F on the optical module 109. For this purpose, the force-generating device 111 includes a fluidic force-generating element 111.1. To this end, the force-generating device 111.1 has a working chamber 111.2 to which a working fluid can be applied by a control device 112. As will be explained in detail below, the control device 112 sets the working pressure of the working fluid which is supplied to the working chamber 111.2 in line with the force F which is to be exerted by the force-generating element 111.1 on the optical module 109.

The force-generating element 111.1 is formed in the manner of a muscle element which exerts a first tensile force F₁ when there is a first working pressure p₁ in the working chamber 111.2 and a second tensile force F₂ which is increased with respect to the first tensile force F₁ when there is a second working pressure p₂ in the working chamber 111.2 which is increased with respect to the first working pressure p₁ (i.e. for p₁<p₂, what applies is F₁<F₂). As far as this is permitted by the mechanical constraints, when there is an increase in the working pressure, the force-generating element 111.1 performs a contraction along its longitudinal axis 111.3. Therefore, when there is an infeed of energy, the force-generating element 111.1 thus performs a contraction in its longitudinal direction (in a way similar to a human muscle) while applying an increasing tensile force F.

The working fluid may be both a liquid medium and a gaseous medium. Both these variants may be of advantage depending on the application. What may always have a role to play is, among others, the desired stiffness for the connection between the optical module 109 and the supporting structure 110. If, for example, a particularly stiff connection of the optical module 109 to the supporting structure 110 is of advantage, then a liquid medium can be used whereas if a lower stiffness is desired, a gaseous medium can be used due to its compressibility.

Fluidic muscle elements of the above kind are sufficiently well known and they will therefore not be explained into in any more detail here. As a rule they include a working chamber which is generally cylindrical and which is bounded by a combination of at least one elastic, fluid-tight wall and one mesh or woven structure of tensile elements (e.g. wires, fracture-resistant filaments, etc.) arranged in an oblique manner to the axis of the cylinder. If the pressure in the working chamber is increased, it expands radially (i.e. transverse to its longitudinal direction). This causes the tensile elements to align themselves more markedly in the circumferential direction of the cylindrical working chamber, meaning that this results in a contraction of the working chamber along its longitudinal axis. An example of a fluidic muscle element of this kind represent the pneumatic muscle elements produced by Festo AG & Co. KG (73734 Esslingen, Del.) which are sold under the name “Fluidic Muscle DMSP” or “Fluidic Muscle MAS” and which are described in the company brochure “Info 501” (issue 2005/04) issued by Festo AG & Co. KG (73734 Esslingen, Del.), the entire disclosure of which is incorporated herein by reference.

The muscle element 111.1 has on the one hand the advantage that it operates without jerks or impacts, thus enabling a force F to be exerted on the optical module 109 particularly gently. This in turn has the advantage that there is no affection of other components of the optical device 108 by any eventual impacts when the muscle element 111.1 is operated. A further advantage of the muscle element 111.1 lies in the fact that, because of its principle of operation of a contraction along its longitudinal axis 111.3, if there is an increase in the working pressure, and because of the resultant exertion of a tensile force, it is insensitive to shear forces, which considerably simplifies the design of the force-generating device 111. In this way, appreciably less expense is involved in decoupling shear forces of this kind or in the guidance relative to one another of the coupled components (i.e. the optical module 109 and the supporting structure 110 in the present case) as compared with conventional fluidic actuators which operate in a similar jerk-free manner (e.g. conventional bellows actuators which exert a compressive force when there is an increase in the working pressure).

To enable the force F exerted on the optical module 109 by the force-generating element 111.1 to be actively influenced, a sensing device 113 is provided which is connected to the control device 112. The sensing device 113 senses the current value of a state variable representative of the state of operation of the optical device 108.

This state variable may on the one hand be any desired variable which can be affected by the action of the force of the force-generating element 111.1 on the optical module 109. It may for example be a variable which is representative of an imaging error in the microlithographic apparatus 101 which is sensed by the sensing device 113 and which can be affected by the action of the force of the force-generating element 111.1 on the optical module 109. In this way, the action of the force of the force-generating element 111.1 may, for example, affect the position and/or orientation of the lens 107.1 (each relative to a preset reference) and/or the geometry thereof, which factors in turn affect the imaging error in the microlithographic apparatus 101. Similarly, it may however also be a force or a moment which is exerted on the optical module 109.

The state variable may however also be any desired variable which is in itself independent of the action of the force of the force-generating element 111.1. It may for example be a variable which is representative of an acceleration acting on the optical device. Similarly, it may be a variable which is representative of a temperature in the optical module 109 or the supporting structure 110, or a variable which is representative of a state variable (e.g. pressure, temperature, etc.) of an atmosphere surrounding the optical module 109 and/or the supporting structure 110.

The sensing device 113 supplies this current value of the state variable which is sensed to the control device 112. The control device 112 compares the current value of the state variable with a setpoint value for the state variable which is preset for the current state of operation and sets the working pressure in the working chamber 111.2 in such a way that any existing difference between the desired value and the actual value is counteracted.

This procedure may have a further regulating circuit superimposed on it. In this way, the control device 112 may for example have a sensor device 112.1 which, depending on the purpose of the action of the force of the force-generating element 111.1, senses a further variable and transmits it to the control device 112, which then sets the working pressure in the working chamber 111.2 by using this further variable.

If the purpose of the action of the force of the force-generating element 111.1 is, for example, primarily the generation of an exactly preset force (e.g. to obtain a precisely defined deformation of the lens 107.1), then the sensor device 112.1 may be designed to measure the force which is exerted by the force-generating element 111.1 on the optical module. Consequently, the sensor device 112.1 may thus take the form of for example a force measuring cell or the like.

If, however, the purpose of the action of the force of the force-generating element 111.1 is, for example, primarily the generation of an exactly preset shift (e.g. to obtain a precisely defined position and/or orientation for the lens 107.1), then the sensor device 112.1 may be designed to measure the shift which is obtained as a result of the action of the force of the force-generating element 111.1. Consequently, the sensor device may thus be an appropriate travel-measuring device which operates according to any desired principle (e.g. an interferometer, encoder, capacitive travel meter, etc.).

In the present case where there is a superimposed further regulating circuit, the desired value for the further variable sensed by the sensor device 112.1 may for example be preset as a function of the desired value of the state variable which is sensed by the sensing device 113. If for example a certain shift and/or deformation of the lens 107.1 is desired, in a variant, to correct an imaging error which is sensed by the sensing device 113, then this shift and/or deformation which is desired can be used as a setpoint value for the superimposed regulating circuit. In another variant, a certain clamping force may need to be applied by the force-generating device 111 to hold the optical module 109 in a preset position, as a function of an acceleration acting on the optical device 108, which acceleration is sensed by the sensing device 113. There is then obtained from this preset clamping force a preset force of the force-generating element 111.1, which can then be used as a setpoint value for the superimposed regulating circuit.

Apart from the force-generating element 111.1, the force-generating device 111 may also include other force-generating components which, together with the force-generating element 111.1, define the force which is exerted by the force-generating device 111 on the optical module 109. A further force-generating component of this kind may be an active or a passive component. For example, what is indicated in FIG. 2 by the dashed outline is an active force-generating component in the form of an active preloading element 111.4, which is likewise connected to the supporting structure 110 and which (under the control of the control device 112) exerts on the optical module 109 a preloading force F_{y} which counteracts the force F from the force-generating element 111.1. The resultant force F_{R} which is exerted on the optical module then (given the directions shown for the forces in FIG. 2) calculates as:

F_{R}=F−F_{V}. (1)

The preloading element (as shown in FIG. 2) may be arranged kinematically in series with the force-generating element 111.1. However, it goes without saying that a preloading element of this kind may equally well be arranged kinematically in parallel with the force-generating element 111.1. If this is the case, it is then designed to exert on the optical module 109 a compressive force which counteracts the tensile force of the force-generating element 111.1.

As mentioned, the preloading element 111.4 is an active element whose preloading force F_{V} can be adjusted under the control of the control device 112. It may be any desired element which generates a force which can be actively adjusted. In particular, it may be an electrical or electro-mechanical element (e.g. piezo actuators, Lorentz actuators, etc.) or again a fluidic force-generating element (e.g. piston, diaphragm or bellows actuators, etc.), in particular a further fluidic muscle element.

However, it goes without saying that in variants of the disclosure which are of a particularly simple design, the preloading element 111.4 may also be a passive force-generating element, such for example as a simple mechanical or pneumatic spring element.

It also goes without saying that a plurality of force-generating device 111 may engage with the optical module 109. For example, three force-generating devices 111 may be provided which are distributed (optionally evenly) around the circumference of the optical module 109 (and therefore also of the lens 107.1), which act in the plane of the optical module 109 and which are able to set the position and orientation of the optical module 109 (and hence of the lens 107.1) in the plane of the optical module 109 in three degrees of freedom (two translational degrees of freedom in and one rotatory degree of freedom). It goes without saying that the optical module 109 may be guided in this case by additional, passive, supporting structures which engage with the optical module 109 and the supporting structure 110.

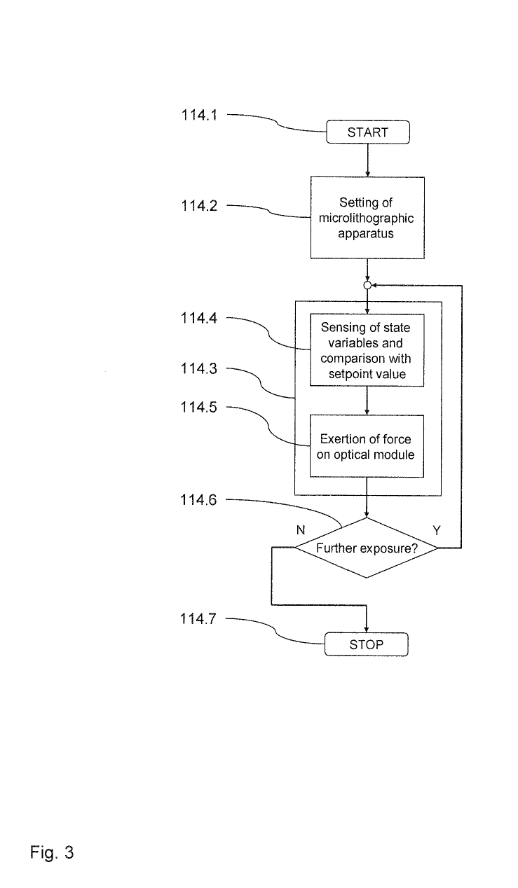

FIG. 3 is a flow chart of an imaging process which is carried out with the microlithographic apparatus 101 and in which use is made of an exemplary embodiment of the method of exerting a force on an optical module.

First, the execution of the process is started in a step 115.1. In a step 115.2, the components of the microlithographic apparatus 101 shown in FIG. 1 are then brought to a state in which the forming as described above of an image of the projection pattern in the mask 103.1 can take place on the substrate 105.1.

In an imaging step 115.3, in parallel with the exposure of the substrate 105.1 in a step 115.4, there take place the sensing as described above of the current value of the state variable by the sensing device 113 and the comparison as described above of this current value with a desired value which is preset for the current state of operation.

In a step 115.5, the control device 112 then controls the force-generating element 111.1 in the way described above such that the force-generating device 111 exerts an appropriate force on the optical module 109.

Following this, a check is made in a step 115.6 to see whether a further imaging step still has to be performed. If this is not the case, the execution of the process is brought to an end in step 115.7. Otherwise a jump is made back to step 115.3.

### Second Exemplary Embodiment

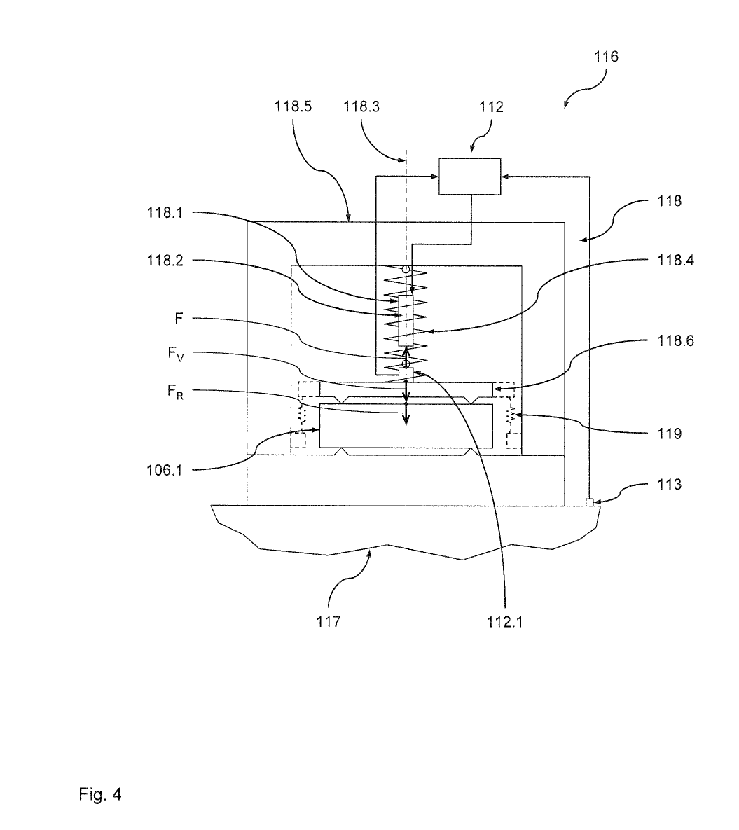

In what follows, a further exemplary embodiment of the optical device 116 according to the disclosure will be described with reference to FIGS. 1 and 4. The optical device 116 is part of the illumination system 102 and includes an optical module in the form of the bar shaped optical element 106.1 and a supporting structure 117. The optical element 106.1 is connected to the supporting structure 117 by a force-generating device 118.

The purpose of the force-generating device 118 is to exert a clamping force F_{R} on the optical module 106.1 and in this way to hold the latter in its preset position relative to the supporting structure 117 even when it is acted on by external forces. For this purpose, the force-generating device 118 once again includes a fluidic force-generating element 118.1. The force-generating element 118.1 has a working chamber 118.2 to which a working fluid can be applied by the control device 112. The control device 112 once again sets the working pressure of the working fluid which is supplied to the working chamber 118.2 in line with the force F which needs to be exerted by the force-generating element 118.1.

The force-generating element 118.1 is once again designed in the manner of a muscle element which exerts a first tensile force F₁ when there is a first working pressure p₁ in the working chamber 118.2 and a second tensile force F₁ which is increased with respect to the first tensile force F₁ when there is a second working pressure p₂ in the working chamber 111.2 which is increased with respect to the first working pressure p₁ (i.e. for p₁<p₂, what applies is F₁<F₂). As far as this is permitted by the mechanical constraints, when there is an increase in the working pressure, the force-generating element 118.1 performs a contraction along its longitudinal axis 118.3. Therefore, when there is an infeed of energy, the force-generating element 118.1 thus performs a contraction in its longitudinal direction (in a way similar to a human muscle) while applying an increasing tensile force F.

The working fluid may be both a liquid medium and a gaseous medium. Both these variants may be of advantage depending on the application. What may in particular have a role to play is, among others, the desired stiffness for the connection between the optical module 106.1 and the supporting structure 117. If, for example, a particularly stiff connection of the optical module 106.1 to the supporting structure 117 is of advantage, then a liquid medium can be used whereas if a lower stiffness is desired a gaseous medium can be used due to its compressibility.

Fluidic muscle elements of the above kind are sufficiently well known and they will therefore not be explained into in any more detail here. An example of a fluidic muscle element of this kind is provided by the pneumatic muscle elements produced by Festo AG & Co. KG (73734 Esslingen, Del.) which are sold under the name “Fluidic Muscle DMSP” or “Fluidic Muscle MAS” and which are described in the company brochure “Info 501” (issue 2005/04) issued by Festo AG & Co. KG (73734 Esslingen, Del.), the entire disclosure of which is incorporated herein by reference.

The muscle element 118.1 has on the one hand the advantage that it operates without jerks or impacts, thus enabling a force F to be exerted on the optical module 106.1 particularly gently. This in turn has the advantage that there is no affection of other components of the optical device 116 by any eventual impacts when the muscle element 118.1 is operated. A further advantage of the muscle element 118.1 lies in the fact that, because of its principle of operation of a contraction along its longitudinal axis 118.3, if there is an increase in the working pressure, and because of the resultant exertion of a tensile force, it is insensitive to shear forces, which considerably simplifies the design of the force-generating device 118. In this way, appreciably less expense is involved in decoupling shear forces of this kind or in the guidance relative to one another of the coupled components (i.e. the optical module 106.1 and the supporting structure 117 in the present case) as compared with conventional fluidic actuators which operate in a similar jerk-free manner (e.g. conventional bellows actuators which exert a compressive force when there is an increase in the working pressure).

To enable the force F which is exerted by the force-generating element 118.1 to be actively influenced, a sensing device 113 is provided which is connected to the control device 112. In the present exemplary embodiment, the sensing device 113 senses (as an actual value of a state variable representative of the state of operation of the optical device 116) the current value of the acceleration a which is acting on the optical device 116 transverse to the direction of the clamping force F_{R}.

The sensing device 113 supplies this current value of the acceleration which is sensed to the control device 112. Using the current value of the acceleration a, the control device 112 determines a setpoint value F_{RS} for the clamping force and sets the working pressure in the working chamber 118.2 in such a way that any existing difference between the setpoint value F_{RS} for the clamping force and its actual value F_{R} is counteracted.

For this purpose, a further regulating circuit is provided for the clamping force. The control device 112 includes a sensor device 112.1 which is arranged kinematically in series with the force-generating element 118.1 and which measures the force F which is exerted by the force-generating element 118.1. Consequently, the sensor device 112.1 may thus take, for example, the form of a force measuring cell or the like.

As mentioned, the setpoint value F_{RS} for the clamping force is preset in the control device 112 as a function of the acceleration a which is sensed by the sensing device 113. The control device 112 then modifies the working pressure of the working fluid until the actual value F_{R} of the clamping force is the same as the setpoint value F_{RS}.

Apart from the force-generating element 118.1, the force-generating device 118 also includes a further force-generating component in the form of a preloading element 118.4 which, together with the force-generating element 118.1, defines the force which is exerted by the force-generating device 118 on the optical module 106.1. The preloading element 118.4 is designed as a simple mechanical spring which is arranged kinematically in parallel with the force-generating element 118.1 with its longitudinal axis extending co-linearly to the longitudinal axis 118.3 of the force-generating element 118.1.

The force-generating element 118.1 and the preloading element 118.4 are each connected on the one hand to a portal 118.5 and on the other hand to a clamping plate 118.6. In the mounted state, the portal 118.5 is fastened to the supporting structure 117 while the clamping plate 118.6 is in contact with the optical module 106.1.

In the exemplary embodiment shown, the preloading element 118.4 is a compression spring which is compressed in the mounted state and which thus exerts on the optical module 106.1 a preloading force in the form of a compressive force F_{V} which counteracts the force F from the force-generating element 118.1. The resultant force F_{R} which is exerted on the optical module (given the directions shown for the forces in FIG. 4) then calculates as:

F_{R}=F_{V}−F. (2)

The preloading element 118.4 is designed such that, in the state shown (where the clamping plate 118.6 is in contact with the optical module 106.1), it exerts a preloading force F_{V} which corresponds to the maximum clamping force F_{Rmax} to be exerted on the optical module 106.1. This maximum clamping force F_{Rmax} is determined from the worst force action on the optical module 106.1 which can be expected when the microlithographic apparatus 101 is being assembled or transported or when it is in operation, for which worst force action it has to be ensured that the optical module 106.1 will not shift relative to the supporting structure 117. Such an adverse force action on the optical module 106.1 may, for example, occur as a result of impact type loads when the microlithographic apparatus 101 is being assembled or transported.

The maximum clamping force F_{Rmax} is typically designed for what has to be assumed as the worst-case situation in which forces corresponding to seven times the acceleration caused by the earth's gravity (7 g) act on the optical module 106.1. However, it is also possible that considerably higher accelerations or forces act on the optical device 116 especially when the optical device 116 is being assembled and transported. Hence the clamping force F_{Rmax} is adapted, if desired, for considerably higher values of acceleration (e.g. up to 20 g).

However, during normal operation of the microlithographic apparatus 101, what usually act on the optical module 106.1 are maximum forces which correspond to three times the acceleration caused by the earth's gravity (3 g). By varying the tensile force F of the force-generating element 118.1 as a function of the acceleration acting on the optical device 116, dynamic matching of the clamping force F_{R} to the current dynamic load on the optical module 106.1 can be achieved in an advantageous way.

The tensile force F of the force-generating element 118.1 is set in this case by the control device 112 in such a way that the clamping force F_{R} is always limited only to the magnitude involved for the current loading situation. By this approach, an appreciable reduction in the clamping force F_{R} and hence in the stresses exerted on the optical module 106.1 can be achieved over wide stretches of the operation of the microlithographic apparatus 101 in comparison with conventional devices in which the optical module is always clamped with the maximum clamping force F_{Rmax}. This leads to a reduction in stress-induced effects, such as, for example, stress-induced birefringence, and thus to image forming of increased quality which can be achieved by the present disclosure in the microlithographic apparatus 101. In this way, stress-induced birefringence can, as a rule, be reduced by the present disclosure, in normal operation where there are no unusual impact loads, to approximately a seventh of the value which exists in conventional devices using a permanent maximum clamping force F_{Rmax (depending on the design of the maximum clamping force F}_{Rmax}, this value may even turn out to be considerably lower).

With the exemplary embodiment shown in FIG. 4 and just described, the maximum clamping force F_{Rmax} is always exerted on the optical module 106.1 if there is a failure of the power supply or of the supply of the force-generating element 118.1 by the control device 112, respectively, and if there is a resultant decline of the tensile force F to a value of zero, thus ensuring that the optical module 106.1 stays in its position even in the worst loading situations which can be expected.

However, it goes without saying that in other variants of the disclosure provision may also be made for the preloading force F_{V} from the preloading element to be designed merely for a maximum loading situation which can be expected in normal operation (e.g. a maximum acceleration of 3 g) and for the force-generating element to exert a tensile force F which acts in the same direction as the preloading force and which absorbs unusual fairly high loads as a result of the clamping force F_{R} on the optical module being increased even further by the force-generating element. It goes without saying in this case that the mechanical arrangement of the force-generating element has to be modified in comparison with the arrangement shown in FIG. 4 such that the tensile force F acts in the same direction as the preloading force F_{V}.

To ensure that the dynamic matching of the tensile force F and hence of the clamping force F_{R} takes place even at the time of transportation, the control device has of course also to be in operation at the time of transportation. However, it goes without saying that, if there is sealing of the appropriate reliability, a working pressure corresponding to the maximum load to be expected can also simply be generated in the working chamber of the force-generating element (the maximum clamping force F_{Rmax} thus being exerted on the optical module) for the eventuality of transportation and the working chamber is then sealed, for example, by a suitable valve. The force-generating element then acts like a preloaded pneumatic spring which, if the system is sealed in the appropriate way, permanently ensures that the maximum clamping force F_{Rmax} is exerted on the optical module even without any input of energy.

It goes without saying that the preloading force F_{V} does not necessarily have to be generated by the compression spring which is shown in FIG. 4. Instead, it is also possible for one or more tensile springs to be used to obtain the preloading force Fv, as in indicated in FIG. 4 by the dashed contour 119.

It also goes without saying that the preloading element may also be an active element the preloading force F_{V} of which can be adjusted under the control of the control device 112. It may be any desired element which generates a force which can be actively adjusted. In particular, it may be an electrical or electro-mechanical element (e.g. piezo actuators, Lorentz actuators, etc.) or again a fluidic force-generating element (e.g. piston, diaphragm or bellows actuators, etc.), in particular a further fluidic muscle element.

It also goes without saying that a plurality of force-generating devices 118 may engage with the optical module 106.1. This applies in particular when there are optical modules of other designs which are clamped by the design according to the disclosure. In this way, when for example an optical module which is symmetrical in rotation has to be clamped, a plurality of force-generating devices may be provided which are distributed (optionally evenly) around the circumference of the optical module and which cooperatively clamp the optical module.

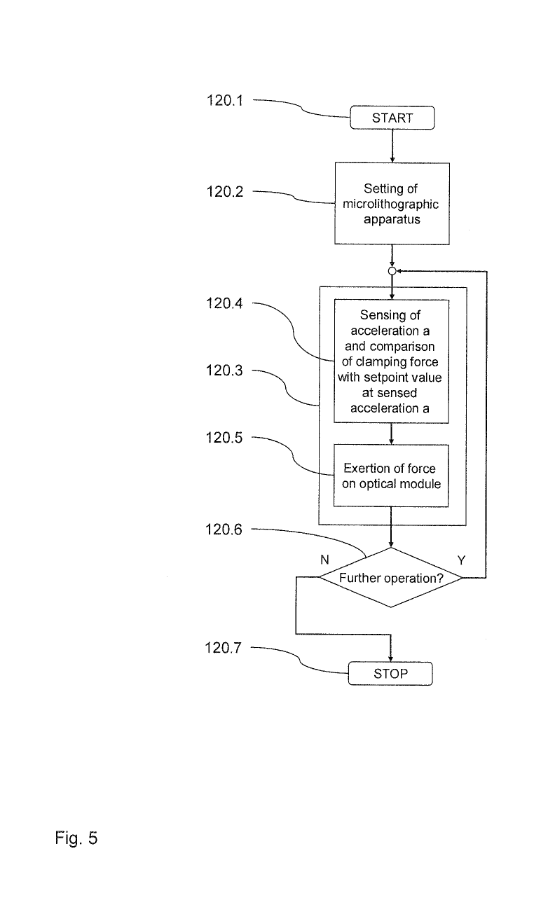

FIG. 5 is a flow chart of an image forming process which is carried out with the microlithographic apparatus 101 and in which use is made of an exemplary embodiment of the method of exerting a force on an optical module.

First, the execution of the process is started in step 120.1. In a step 120.2, the components of the microlithographic apparatus 101 shown in FIG. 1 are then brought to a state in which the forming as described above of an image of the projection pattern in the mask 103.1 can take place on the substrate 105.1.

In this case the arrangement shown in FIG. 4 can be advantageously used to exert a precisely defined clamping force F_{R} on the optical module 106.1. For this purpose the preloading element 118.4 is preloaded by the force-generating element 118.1 to the maximum clamping force F_{Rmax} under the control of the control device 112 before the portal 118.5 is fitted to the supporting structure 117. The tensile force F from the force-generating element 118.1 is set by using the force sensor 112.1 and it corresponds of course in this case to the maximum clamping force F_{Rmax}.

The portal 118.5 is then moved towards the supporting structure 117 until, when the clamping plate 118.6 makes contact with the optical module 106.1, a change in the tensile force F (which is a decline in the tensile force F in the present case) is recorded via the force sensor 112.1. In this position, the portal 118.5 is fixed in place in relation to the supporting structure 117 and the tensile force F is reduced to the requisite value corresponding to the current loading situation. With this procedure, it is thus ensured that it is always a precisely defined clamping force F_{R} which acts on the optical module 106.1. If for example the tensile force of the force-generating device 118.1 is reduced to a value of zero, then the optical module is clamped precisely with the maximum clamping force F_{Rmax} by the preloading element of 118.4.

In a step 120.3, in parallel with the operation of the microlithographic apparatus 101 in a step 120.4, there take place the sensing as described above of the current value of the acceleration a by the sensing device 113 and the comparison as described above of the current value of the clamping force F_{R} with a desired value F_{RS} which is preset for the current acceleration.

In a step 120.5, the control device 112 then controls the force-generating element 118.1 in the way described above in such a way that the force-generating device 118 exerts an appropriate clamping force F_{R} on the optical module 106.1.

Following this, a check is made in a step 120.6 to see whether the microlithographic apparatus is to continue to operate. If this is not the case, the execution of the process is brought to an end in step 120.7. Otherwise a jump is made back to step 120.3.

### Third Exemplary Embodiment

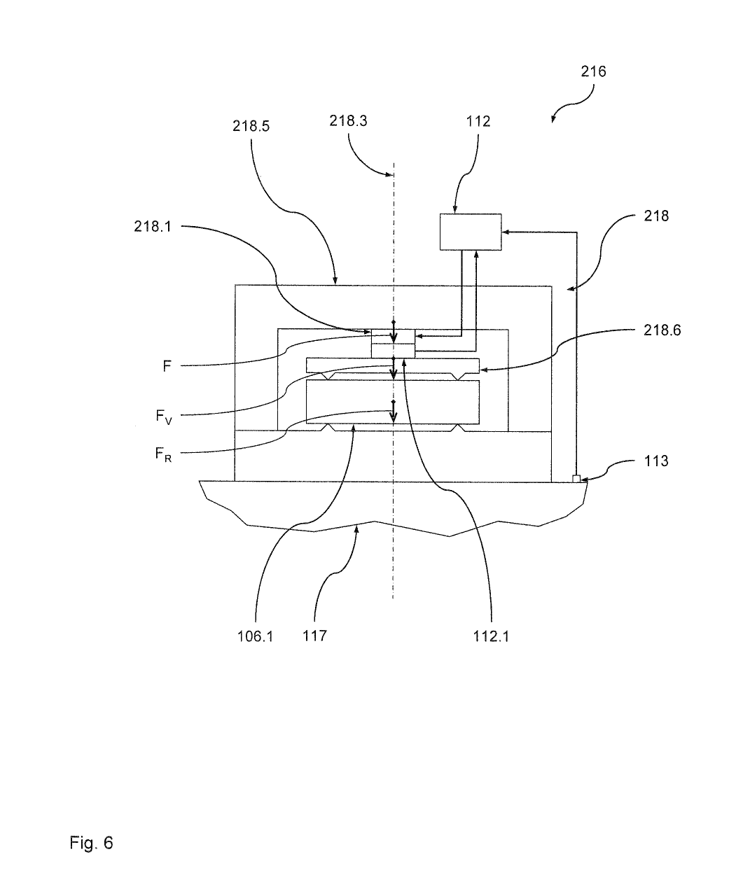

In the following, a further exemplary embodiment of the optical device 216 according to the disclosure which can be used in the microlithographic apparatus 101 in place of the optical device 116 will be described with reference to FIGS. 1 and 6. The basic construction and the operation of the optical device 216 correspond to those of the optical device 116 shown in FIG. 4 and it will therefore be merely the differences which are gone into here. In particular, similar components are given references numerals which are increased by the value 100 and regarding their features reference is made to the explanations given above.

The difference with respect to the optical device 116 lies merely in the design of the force-generating device 218. This force-generating device 218 includes as its force-generating element a piezoelectric element 218.1 by which, as in the second exemplary embodiment, the clamping force F_{R} can be matched to the current loading situation of the optical device 216. In the present exemplary embodiment (when the force-generating element 218.1 is switched off) the preloading force F_{V} is obtained by the elastic deformation of the components situated in the line of force transmission between the supporting structure 117 and the optical module 106.1 (and the elastic deformation in particular of the portal 218.5). The preloading force F_{V} is adapted in this case merely for a maximum loading situation which is to be expected in normal operation (e.g. for a maximum acceleration of 3 g).

In the activated state the force-generating element 218.1 exerts a compressive force F which is directed in the same direction as the preloading force and which absorbs unusual fairly high loads as a result of the clamping force F_{R} on the optical module being increased even further by the force-generating element 218.1. The compressive force F is set in this case, under the control of the control device 112, as a function of a current acceleration a which is sensed by the sensing device 113 and as a function of the clamping force F_{R} which is sensed by the sensor device 112.1.

However, it goes without saying that in other variants of the disclosure, provision may once again be made for the maximum clamping force F_{Rmax} to be obtained when the force-generating element is switched off and a reduction in the clamping force F_{R} to be obtained when the force-generating element is activated or if voltage is applied to it, respectively.

It also goes without saying that, in other variants of the disclosure, any desired other electrical or electro-mechanical elements (e.g. Lorentz actuators) or fluidic force-generating elements (e.g. piston, diaphragm or bellows actuators, etc.) can also be used for the force-generating element by which the dynamic matching of the clamping force F_{R} to the current loading situation is performed.

### Fourth Exemplary Embodiment

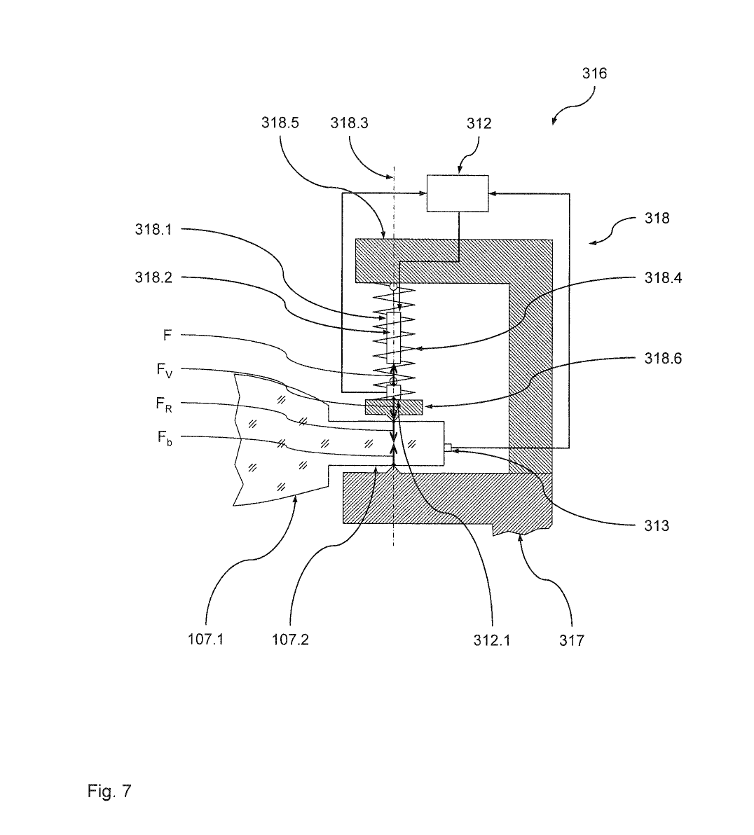

In the following, a further exemplary embodiment of the optical device 316 according to the disclosure will be described with reference to FIGS. 1 and 7. The optical device 316 is part of the objective 104 and includes an optical module in the form of the optical element 107.1 and a supporting structure 317. In the present exemplary embodiment, the optical element is designed in the form of a lens 107.1. The lens 107.1 has a step 107.2 at its outer circumference. In the region of the step 107.2 the lens 107.1 is connected to the supporting structure 317 by a force-generating device 318.

The purpose of the force-generating device 318 is to exert a clamping force F_{R} on the step 107.2 and therefore on the optical module 107.1 and to hold the latter in its preset position relative to the supporting structure 317 in this way even when it is acted on by external forces. For this purpose, the force-generating device 318 once again includes a fluidic force-generating element 318.1. The force-generating element 318.1 has a working chamber 318.2 to which a working fluid is applied by the control device 312. The control device 312 once again sets the working pressure of the working fluid which is supplied to the working chamber 318.2 in correspondence with the force F which needs to be exerted by the force-generating element 318.1.

The force-generating element 318.1 is once again formed in the manner of a muscle element which exerts a first tensile force F₁ when there is a first working pressure p₁ in the working chamber 318.2 and a second tensile force F₁ which is increased with respect to the first tensile force F₁ when there is a second working pressure p₂ in the working chamber 318.2 which is increased with respect to the first working pressure p₁ (i.e. for p₁<p₂, what applies is F₁<F₂). As far as this is permitted by the mechanical constraints, when there is an increase in the working pressure the force-generating element 318.1 performs a contraction along its longitudinal axis 318.3. Therefore, when there is an infeed of energy, the force-generating element 318.1 thus performs a contraction in its longitudinal direction (in a way similar to a human muscle) while applying an increasing tensile force F.

The working fluid may be both a liquid medium and a gaseous medium. Both these variants may be of advantage depending on the application. What may in particular have a role to play is, among others, the desired stiffness for the connection between the optical module 107.1 and the supporting structure 317. If, for example, a particularly stiff connection of the optical module 107.1 to the supporting structure 317 is of advantage, then a liquid medium can be used, whereas if a lower stiffness is desired, a gaseous medium can be used due to its compressibility.

Fluidic muscle elements of this kind are sufficiently well known and they will therefore not be gone into in any more detail here. An example of a fluidic muscle element of this kind is provided by the pneumatic muscle elements produced by Festo AG & Co. KG (73734 Esslingen, Del.) which are sold under the name “Fluidic Muscle DMSP” or “Fluidic Muscle MAS” and which are described in the company brochure “Info 501” (issue 2005/04) issued by Festo AG & Co. KG (73734 Esslingen, Del.), the entire disclosure of which is incorporated herein by reference.

The muscle element 318.1 has on the one hand the advantage that it operates without jerks or impacts, thus enabling a force F to be exerted on the optical module 107.1 particularly gently. This in turn has the advantage that there is no affection of other components of the optical device 316 by any eventual impacts when the muscle element 318.1 is operated. A further advantage of the muscle element 318.1 lies in the fact that, because of its principle of operation of a contraction along its longitudinal axis 318.3, if there is an increase in the working pressure, and because of the resultant exertion of a tensile force, it is insensitive to shear forces, which considerably simplifies the design of the force-generating device 318. In this way, appreciably less expense is involved in decoupling shear forces of this kind or in the guidance relative to one another of the coupled components (i.e. the optical module 107.1 and the supporting structure 317 in the present case) as compared with conventional fluidic actuators which operate in a similar jerk-free manner (e.g. conventional bellows actuators which exert a compressive force when there is an increase in the working pressure).

To enable the force F which is exerted by the force-generating element 318.1 to be actively influenced, a sensing device 313 is provided which is connected to the control device 312. In the present exemplary embodiment, the sensing device 313 senses (as an actual value of a state variable representative of the state of operation of the optical device 316) the current value of the acceleration a which is acting on the optical device 316 at right angles to the direction of the clamping force F_{R}.

The sensing device 313 supplies this current value of the acceleration which is sensed to the control device 312. Using the current value of the acceleration a, the control device 312 determines a setpoint value F_{RS} for the clamping force and sets the working pressure in the working chamber 318.2 in such a way that any existing difference between the setpoint value F_{RS} for the clamping force and its actual value F_{R} is counteracted.

For this purpose, a further regulating circuit is provided for the clamping force. The control device 312 includes a sensor device 312.1 which is arranged kinematically in series with the force-generating element 318.1 and which measures the force F which is exerted by the force-generating element 318.1. Consequently, the sensor device 312.1 may thus may be designed, for example, as a force measuring cell or the like.

As mentioned, the setpoint value F_{RS} for the clamping force is preset in the control device 312 as a function of the acceleration a which is sensed by the sensing device 313. The control device 312 then modifies the working pressure of the working fluid until the actual value F_{R} of the clamping force is the same as the setpoint value F_{RS}.

Apart from the force-generating element 318.1, the force-generating device 318 also includes a further force-generating component in the form of a preloading element 318.4 which, together with the force-generating element 318.1, defines the force which is exerted by the force-generating device 318 on the optical module 107.1. The preloading element 318.4 is designed as a simple mechanical spring which is arranged kinematically in parallel with the force-generating element 318.1 with its longitudinal axis extending co-linearly to the longitudinal axis 318.3 of the force-generating element 318.1

The force-generating element 318.1 and the preloading element 318.4 are each connected on the one hand to an abutment 318.5 and on the other hand to a clamping plate 318.6. In the mounted state, the abutment 318.5 is fastened to the supporting structure 317 while the clamping plate 318.6 is in contact with the optical module 107.1.

In the exemplary embodiment shown, the preloading element 318.4 is a compression spring which is compressed in the mounted state and which thus exerts on the optical module 107.1 a preloading force in the form of a compressive force F_{V} which counteracts the force F from the force-generating element 318.1. The resultant force F_{R} which is exerted on the optical module (given the directions shown for the forces in FIG. 7), then calculates according to equation 2 as:

F_{R}=F_{V}−F.

The preloading element 318.4 is designed such that in the state shown (where the clamping plate 318.6 is in contact with the optical module 107.1) it exerts a preloading force F_{V} which corresponds to the maximum clamping force F_{Rmax} to be exerted on the optical module 107.1. This maximum clamping force F_{Rmax} is determined from the worst force action on the optical module 107.1 which can be expected when the microlithographic apparatus 101 is being assembled or transported or when it is in operation, for which worst force action it has to be ensured that the optical module 107.1 will not shift relative to the supporting structure 317. An adverse force action of this kind on the optical module 107.1 may for example occur as a result of impact type loads when the microlithographic apparatus 101 is being assembled or transported.

The maximum clamping force F_{Rmax} is typically designed for what has to be assumed as the worst-case situation in which forces corresponding to seven times the acceleration caused by the earth's gravity (7 g) act on the optical module 107.1. However, it is also possible for considerably higher accelerations or forces to act on the optical device 316 especially when the optical device 316 is being assembled and transported. Hence, the clamping force F_{Rmax} is designed if desired for considerably higher values of acceleration (e.g. up to 20 g).

However, during normal operation of the microlithographic apparatus 101, what usually act on the optical module 107.1 (i.e. on the lens 107.1) are maximum forces which correspond to three times the acceleration caused by the earth's gravity (3 g). By varying the tensile force F from the force-generating element 318.1 as a function of the acceleration acting on the optical device 316, dynamic matching of the clamping force F_{R} to the current dynamic load on the optical module 107.1 can be achieved in an advantageous way.

The tensile force F from the force-generating element 318.1 is set in this case by the control device 312 in such a way that the clamping force F_{R} is always limited only to the magnitude involved for the current loading situation. By this approach, an appreciable reduction in the clamping force F_{R} and hence in the stresses exerted on the optical module 107.1 can be achieved over wide stretches of the operation of the microlithographic apparatus 101 in comparison with conventional devices in which the optical module is always clamped with the maximum clamping force F_{Rmax}. This leads to a reduction in stress-induced effects, such as stress-induced birefringence, and thus to image forming of increased quality which can be achieved by the present disclosure in the microlithographic apparatus 101. In this way, stress-induced birefringence can, as a rule, be reduced by the present disclosure, during normal operation where there are no unusual impact loads, to approximately a seventh of the value which exists in conventional devices using permanent maximum clamping force F_{Rmax} (depending on the design of the maximum clamping force F_{Rmax}, this value may even turn out to be considerably lower).

With the exemplary embodiment shown in FIG. 7 and just described, the maximum clamping force F_{Rmax} is always exerted on the optical module 107.1 if there is a failure of the power supply or of the supply of the force-generating element 318.1 by the control device 312, respectively, and if there is a resultant decline of the tensile force F to a value of zero, thus ensuring that the optical module 107.1 stays in its position even in the worst loading situations which can be expected.

However, it goes without saying that in other variants of the disclosure provision may also be made for the preloading force F_{V} from the preloading element to be designed merely for a maximum loading situation which can be expected in normal operation (e.g. a maximum acceleration of 3 g) and for the force-generating element to exert a tensile force F which acts in the same direction as the preloading force and which absorbs unusual fairly high loads as a result of the clamping force F_{R} on the optical module being increased even further by the force-generating element. It goes without saying in this case that the mechanical arrangement of the force-generating element has to be modified in comparison with the arrangement shown in FIG. 4 such that the tensile force F acts in the same direction as the preloading force F_{V}.

To ensure that the dynamic matching of the tensile force F and, hence, of the clamping force F_{R} takes place even at the time of transportation, the control device 312 has of course also to be in operation at the time of transportation. However, it goes without saying that, if there is sealing of the appropriate reliability, a working pressure corresponding to the maximum load expected can also simply be generated in the working chamber of the force-generating element (the maximum clamping force F_{Rmax} thus being exerted on the optical module) for the eventuality of transportation and the working chamber is then sealed by, for example, a suitable valve. The force-generating element then acts like a preloaded pneumatic spring which, if the system is sealed in the appropriate way, permanently ensures that the maximum clamping force F_{Rmax} is exerted on the optical module even without any input of energy.

It goes without saying that the preloading force F_{V} does not necessarily have to be generated by the compression spring which is shown in FIG. 7. Instead, it is also possible for one or more tensile springs to be used to obtain the preloading force Fᵥ (in a similar way to what is done by an arrangement as indicated in FIG. 4 by the dashed contour 119).

It also goes without saying that the preloading element may also be an active element whose preloading force F_{V} can be adjusted under the control of the control device 312. It may be any desired element which generates a force which can be actively adjusted. In particular, it may be an electrical or electro-mechanical element (e.g. piezo actuators, Lorentz actuators, etc.) or again a fluidic force-generating element (e.g. piston, diaphragm or bellows actuators, etc.) and in particular a further fluidic muscle element.

It also goes without saying that in a majority of cases a plurality of force-generating devices 318 engage with the optical module 107.1. This applies in particular in the case of lenses which are of a conventional form which is symmetrical in rotation. In this way, what are then provided are, as a rule, a plurality of force-generating devices which are distributed (optionally evenly) around the circumference of the optical module and which cooperatively clamp the optical module.

In a further variant, to enable the force F exerted by the force-generating element 318.1 (in the form of a further current value of a state variable representative of the state of operation of the optical device 316) to be actively influenced, the sensing device 313 may sense in addition the current value of the acceleration b which acts on the optical device 316 in the direction of the clamping force F_{R}.

The sensing device 313 supplies this current value of the acceleration b which is sensed to the control device 312. By reference to the current values of the accelerations a and b, the control device 312 determines a setpoint value F_{RS} for the clamping force and sets the working pressure in the working chamber 318.2, via the regulating circuit described above, in such a way that any existing difference between the setpoint value F_{RS} for the clamping force and its actual value F_{R} is counteracted.

As mentioned, the setpoint value F_{RS} for the clamping force is preset in the control device 312 as a function of the accelerations a and b which are sensed by the sensing device 313. The control device 312 then modifies the working pressure of the working fluid until the actual value F_{R} of the clamping force is the same as the setpoint value F_{RS}.

The setpoint value F_{RS} is selected in this case such that the tensile force F from the force-generating element 318.1 is set by the control device 312 in such a way that the clamping force F_{R} is on the one hand always limited only to the magnitude involved for the current loading situation. By this approach, an appreciable reduction in the clamping force F_{R} and, hence, in the stresses exerted on the optical module 107.1 can be achieved over wide stretches of the operation of the microlithographic apparatus 101 in comparison with conventional devices in which the optical module is always clamped with the maximum clamping force F_{Rmax}. This leads to a reduction in stress-induced effects, such as stress-induced birefringence in the lens 107.1, and thus to image forming of increased quality which can be achieved by the present disclosure in the microlithographic apparatus 101. In this way, stress-induced birefringence can, as a rule, be reduced by the present disclosure, in normal operation where there are no unusual impact loads, to approximately a seventh of the value which exists in conventional devices using a permanent maximum clamping force F_{Rmax} (depending on the design of the maximum clamping force F_{Rmax}, this value may even turn out to be considerably lower).

Provision may also be made for the clamping force F_{R} (which is varied if desired in the manner described above in line with the transverse acceleration a) to be held constant as a function of the axial acceleration b. The resultant force F_{R} which is exerted on the optical module (in the present dynamic case) then, as an expansion of the static case dealt with in equation 2 and if the acceleration a is constant, (given the directions of forces shown in FIG. 7) calculates as:

F_{R}=F_{V}−F−F_{b}=const, (3)

where F_{b} is the force of reaction to the inertial force (resulting from the acceleration b of the lens 107.1). In other words, what can be achieved in this way is that, with constant acceleration a and regardless of the axial acceleration b, the same resultant clamping force always acts on the lens 107.1, which means that, this being the same, the stresses resulting from the clamping which are applied to the lens 107.1 remain constant. This leads to a reduction in stress-induced effects, such for example as the stress-induced birefringence, and hence to image forming of increased quality.

It should be mentioned at this point that the method which was described in connection with FIG. 3 can equally well be carried out with the optical device 316, what are sensed as the state variables being the acceleration a and, if desired, the acceleration b and these state variables being taken into account in the manner described.

### Fifth Exemplary Embodiment

In the following, a further exemplary embodiment of optical device 416 according to the disclosure which can be used in the microlithographic apparatus 101 in place of the optical device 316 will be described with reference to FIGS. 1 and 7. The basic construction and the operation of the optical device 416 correspond to those of the optical device 316 shown in FIG. 7 and it will therefore be merely the differences which are gone into here. In particular, similar components are given references numerals which are increased by the value 100 and regarding their features reference is made to the explanations given above.

The difference with respect to the optical device 316 lies on the one hand merely in the design of the force-generating device 418 and on the other hand merely in the optical module 407.1, which in the present exemplary embodiment is a reflective optical element in the form of a mirror or the like.

The force-generating device 418 includes as its force-generating element a piezoelectric element 418.1 by which, as in the third exemplary embodiment, the clamping force F_{R} can be matched dynamically to the current loading situation of the optical device 416. In the present exemplary embodiment (when the force-generating element 418.1 is switched off) the preloading force F_{V} is obtained by the elastic deformation of the components situated in the line of force transmission between the supporting structure 317 and the optical module 307.1 (and the elastic deformation in particular of the abutment 418.5). The preloading force F_{V} is designed in this case merely for a maximum loading situation which is to be expected in normal operation (e.g. for a maximum acceleration of 3 g).

In the activated state, the force-generating element 418.1 exerts a compressive force F acting in the same direction as the preloading force, which compressive force F absorbs unusual fairly high loads as a result of the clamping force F_{R} on the optical module being increased even further by the force-generating element 418.1. The compressive force F is set in this case, under the control of the control device 112, as a function of a current acceleration a which is sensed by the sensing device 113 and as a function of the clamping force F_{R} which is sensed by the sensor device 112.1.

However, it goes without saying that in other variants of the disclosure provision may once again be made for the maximum clamping force F_{Rmax} to be obtained when the force-generating element is switched off and a reduction in the clamping force F_{R} to be obtained when the force-generating element is activated or a voltage is applied to it, respectively.

It also goes without saying that, in other variants of the disclosure, setting of the clamping force as a function of the accelerations a and b can be performed (in the way which was described above in connection with optical device 316) as well in the optical device 416.

The microlithographic apparatus 101 in which the optical device 416 can be used is an apparatus which operates in the so-called VUV range using light of a wavelength of 193 nm. However, it goes without saying that the optical device 416 can also be used in image forming devices which use light of any desired other wavelength for the image forming. In particular, the optical device 416 can be used in a so-called EUV system which works with light in the so-called EUV range of a wavelength of approximately 5 nm to 20 nm, in particular, with light of a wavelength of approximately 13 nm. It is precisely at these extremely short wavelengths that the advantage of a reduction in stress-induced effects leading to image forming errors which can be achieved with the disclosure may have particularly beneficial effects.

Finally, it goes without saying that, in other variants of the disclosure, any desired other electrical or electro-mechanical force-generating elements (e.g. Lorentz actuators) or fluidic force-generating elements (e.g. piston, diaphragm or bellows actuators, etc.) can also be used for the force-generating element by which the dynamic matching of the clamping force F_{R} to the current loading situation is performed.

The present disclosure has been described above with reference to exemplary embodiments in which only refractive or reflective optical elements were used. It should however again be pointed out here that the disclosure can of course also be used, particularly in the case of image forming at other wavelengths, in connection with optical devices which, alone or in any desired combination, include refractive, reflective or diffractive optical elements.

The present disclosure has also been described above with reference to exemplary embodiments in which only optically active elements of an objective or an illumination device were manipulated. It should however again be pointed out here that the disclosure can of course also be used to apply force to any other optically active components of the imaging device, and in particular to components of the mask device and/or the substrate device.

Finally, it should be pointed out that the present disclosure has been described above with reference to exemplary embodiments from the field of microlithography. However, it goes without saying that the present disclosure can equally well be used for any desired other applications or imaging processes, and in particular at any desired wavelengths for the light used for the image forming.

What is claimed is:

1. An optical device, comprising:
an optical module;
a supporting structure; and
a force-generating device connected to the optical module and the supporting structure,
wherein the force-generating device is configured to exert a clamping force on the optical module, and the force-generating device is configured to vary the clamping force as a function of an acceleration acting on the optical module.

2. The optical device according to claim 1, further comprising:
a control device connected to the force-generating device; and
a sensing mechanism connected to the control device,
wherein:
the sensing mechanism is configured to sense a current value of a state variable representative of a state of operation of the optical device;
a setpoint value for the clamping force is based on a value of the state variable;
the control device is configured to set the clamping force based on a current setpoint value which is based on the current value of the state variable; and
the setpoint value can be substantially constant over a presettable range of values of the state variable.

3. The optical device according to claim 2, wherein the state variable is representative of a force or acceleration which acts on the optical module in at least one degree of freedom.

4. The optical device according to claim 1, wherein the force-generating device has a force-generating element comprising a chamber to which a fluid can be applied.

5. The optical device according to claim 4, wherein:
the force-generating element is a muscle element configured to exert a first tensile force when the fluid applies a first pressure to the chamber;
the force-generating element is a muscle element configured to exert a second tensile force when the fluid applies a second pressure to the chamber; and
the second tensile force is larger than the first tensile force when the second pressure is larger than the first pressure.

6. The optical device according to claim 1, wherein the force-generating device comprises a preloading element configured to exert, in at least one state of operation, a preloading force which counteracts a tensile force of the force-generating element.

7. The optical device according to claim 6, wherein the preloading element comprises at least one element selected from the group consisting of a mechanical spring device and a fluidic preloading device.

8. The optical device according to claim 6, wherein the force-generating element is arranged mechanically in parallel with the preloading element.

9. The optical device according to claim 1, wherein the optical module comprises an optical element.

10. The optical device according to claim 9, further comprising a holding device configured to hold the optical element, wherein the force-generating device is configured to exert its force on the holding device.

11. The optical device according to claim 10, wherein the optical element is a bar shaped element which is held at one end by the holding device, or the optical element is an element which has an outer circumference which is held by the holding device in a region of the outer circumference.

12. The optical device according to claim 1, further comprising a force measuring device configured to measure the clamping force.

13. An apparatus, comprising:
an illumination device configured to illuminate an object having a pattern; and
a projection device comprising a plurality of optical elements configured to form an image of the pattern on a substrate,
wherein:
the illumination device and/or the projection device comprises an optical device;
the optical device comprises an optical module, a supporting structure and a force-generating device;
the force-generating device is connected to the optical module and the supporting structure;
the force-generating device is configured to exert a clamping force on the optical module; and
the force-generating device is designed to vary the clamping force based on an acceleration acting on the optical module.

14. A method, comprising:
using a force-generating device to exert a clamping force on an optical module supported by a supporting structure, the force-generating device being connected to the optical module and the supporting structure; and
varying the clamping force as a function of an acceleration acting on the optical module.

15. The method according to claim 14, further comprising:
sensing a current value of a state variable which is representative of a state of operation of the optical device;
determining a setpoint value for the clamping force based on the value of the state variable; and
setting the clamping force based on the setpoint value,
wherein the setpoint value can be substantially constant over a presettable range of values of the state variable.

16. The method according to claim 15, wherein the state variable is representative of a force or an acceleration which acts on the optical module in at least one degree of freedom.

17. The method according to claim 14, wherein the force-generating device comprises a force-generating element having a chamber to which a working fluid can be applied.

18. The method according to claim 17, wherein the force-generating element is designed as a muscle element which exerts a first tensile force when the fluid applies a first pressure to the chamber and a second tensile force when the fluid applies a second pressure to the chamber, and
wherein the first tensile force is greater than the second tensile force when the first pressure is greater than the second pressure.

19. The method according to claim 14, wherein the force-generating device comprises a preloading element that exerts, in at least one state of operation, a preloading force which counteracts the clamping force.

20. The method according to claim 19, further comprising:
measuring the clamping force;
preloading the preloading element by a presettable force of the force-generating element before the force-generating device contacts the optical module;
moving the force-generating device toward the optical module until contact between the force-generating device and the optical module is sensed via a presettable change in the measured force of the force-generating element; and
reducing the clamping force to a presettable value.

21. The method according to claim 19, wherein the preloading force is generated mechanically and/or fluidically.

22. The method according to claim 14, wherein the optical module comprises an optical element which is held by a holding device, and the clamping force is exerted on the holding device.

23. The method according to claim 14, wherein the force-generating element is a muscle element configured to exert a first tensile force at a first pressure and a second tensile force at a second pressure, and
wherein the first tensile force is greater than the second tensile force when the first pressure is greater than the second pressure.
